(19) United States
(12) Patent Application Publication
(10) Pub. No.: US 2020/0117045 A1
(43) Pub. Date: Apr. 16, 2020

(54) LIQUID CRYSTAL DISPLAY PANEL AND PIXEL STRUCTURE THEREOF AND LIQUID CRYSTAL DISPLAY DEVICE

(71) Applicant: Chunchi CHEN, Huizhou Guangdong (CN)

(72) Inventor: Chunchi CHEN, Huizhou Guangdong (CN)

(21) Appl. No.: 15/749,493

(22) PCT Filed: Jan. 19, 2018
(86) PCT No.: PCT/CN2018/073481

§ 371 Date: Jan. 31, 2018

(30) Foreign Application Priority Data
Dec. 28, 2017 (CN) 201711465366.6

(51) Int. Cl. G02F 1/1335

(52) U.S. Cl. CPC G02F 1/133514; G02F 1/1368; G02F 2201/52

(57) ABSTRACT

A liquid crystal display panel and a pixel structure thereof are provided. The pixel structure includes a red sub-pixel, a green sub-pixel, and a blue subpixel sequentially arranged, wherein an area of the green sub-pixel is larger than an area of the red sub-pixel, and an area of the blue subpixel is smaller than the area of the red sub-pixel. The disclosure further provides a liquid crystal display device including the above-mentioned liquid crystal display panel. In the liquid crystal display panel and the pixel structure thereof provided by the embodiment of the disclosure, the locus of the color coordinate of the white point of the display panel is modulated by adjusting the area ratio of each color sub-pixel, so the problem of the bluish image in low grayscale of the display panel could be solved.

### RELATED APPLICATIONS

The present application is a National Phase of International Application Number PCT/CN2018/073481, filed Jan. 19, 2018, and claims the priority of China Application No. 201711465366.6, filed Dec. 28, 2017.

### FIELD OF THE DISCLOSURE

The disclosure relates to a display technical field, and more particularly to a liquid crystal display panel and a pixel structure thereof and further particularly to a liquid crystal display device including the liquid crystal display panel.

### BACKGROUND

Liquid crystal display (LCD) is a flat thin display device consisting of a certain number of color or black and white pixels, and placed in front of the light source or the reflector. LCD has the characteristics such as low power consumption, high quality, small size, light weight, so LCD has become the mainstream display device. The liquid crystal display device includes a backlight unit and a liquid crystal display panel. The principle of color for a liquid crystal display is generally as follows: the white light from the backlight unit is controlled by the switch of the liquid crystal display panel, and the light intensity of different pixels is controlled, then the color filter is performed by color resist layers having red (R), green (G) and blue (B) to obtain different intensities of red, green and blue light. That is, through mixing the primary colors of red, green and blue to get the color image.

As shown in FIG. 1, in the prior art, the liquid crystal display panel includes a plurality of pixel units 1 arranged in matrix, each of the pixel units 1 includes a red sub-pixel R, a green sub-pixel G, and a blue subpixel B sequentially arranged, and the areas of the red sub-pixel, the green sub-pixel and the red sub-pixel are the same. FIG. 2 is a chromaticity diagram of the liquid crystal display panel in FIG. 1, the curve L1 is a locus of the variation of the color coordinate of the white point from 0 grayscale to 255 grayscale. FIG. 3 is a graph showing the variation curves of each component of the color coordinate of the white point corresponding to the chromaticity diagram in FIG. 2, it should be noted that, in FIG. 3, the curves of the X component and the Y component are almost overlapped. The X component is mainly affected by the red light, the Y component is mainly affected by the green light, and the Z component is mainly affected by the blue light in the color coordinate of the white point of the liquid crystal display panel. As shown in FIG. 2 and FIG. 3, in the low grayscale region, the ratio of the Z component in the color coordinate of the white point is large, so the liquid crystal display panel will display a bluish image. The color difference parameter is 0.073, and the display quality is decreased.

### SUMMARY

A technical problem to be solved by the disclosure is to provide a liquid crystal display panel and a pixel structure thereof, and the locus of the color coordinate of the white point of the display panel is modulated, so the problem of the bluish image in low grayscale of the display panel could be solved.

To achieve the above object, according to one aspect, the embodiment of the disclosure provides a pixel structure of a liquid crystal display panel including a red sub-pixel, a green sub-pixel, and a blue subpixel sequentially arranged, wherein an area of the green sub-pixel is larger than an area of the red sub-pixel, and an area of the blue subpixel is smaller than the area of the red sub-pixel.

In one embodiment, a ratio of the area of the green sub-pixel to the area of the red sub-pixel is 1.2˜1.5.

In one embodiment, a ratio of the area of the blue sub-pixel to the area of the red sub-pixel is 0.5˜0.8.

In one embodiment, a ratio of the area of the red sub-pixel to the area of the green sub-pixel to the area of the blue sub-pixel is 1:1.2:0.8.

The disclosure further provides a liquid crystal display panel including a plurality of pixel structures arranged in matrix, wherein each of the pixel structures is the above-mentioned pixel structure.

In one embodiment, the liquid crystal display panel includes a bottom polarizer, a thin film transistor array substrate, a liquid crystal layer, a color filter substrate, and a top polarizer sequentially disposed.

The disclosure further provides a liquid crystal display device including a liquid crystal display panel and a backlight module, the liquid crystal display panel is disposed opposite to the backlight module, the backlight module is configured to provide a display light source to the liquid crystal display panel, and the liquid crystal display panel is configured to display an image, wherein the liquid crystal display panel is the above-mentioned liquid crystal display panel.

In the liquid crystal display panel and the pixel structure thereof provided by the embodiment of the disclosure, the locus of the color coordinate of the white point of the display panel is modulated by adjusting the area ratio of each color sub-pixel. Specifically, based on the red sub-pixel, the area of the green sub-pixel is arranged to be larger than the area of the red sub-pixel, the area of the blue sub-pixel is arranged to be smaller than the area of the red sub-pixel, so the problem of the bluish image in low grayscale of the display panel could be solved and the display quality could be increased. In addition, the above-mentioned pixel structure could also improve the overall light transmittance of the liquid crystal display panel.

### BRIEF DESCRIPTION OF THE DRAWINGS

FIG. 1 is a structural schematic plan view of a liquid crystal display panel of the prior art;

FIG. 2 is a chromaticity diagram of the liquid crystal display panel in FIG. 1;

FIG. 3 is a graph showing the variation curves of each component of the color coordinate of the white point corresponding to the chromaticity diagram in FIG. 2;

FIG. 4 is a structural schematic section view of a liquid crystal display panel according to an embodiment of the disclosure;

FIG. 5 is a structural schematic plan view of a liquid crystal display panel according to an embodiment of the disclosure;

FIG. 6 is a structural schematic view of a pixel structure according to an embodiment of the disclosure;

FIG. 7 is chromaticity diagram of a liquid crystal display panel according to an embodiment of the disclosure;

FIG. 8 is a structural schematic view of a liquid crystal display device according to an embodiment of the disclosure.

### DETAILED DESCRIPTION OF PREFERRED EMBODIMENTS

In order for the purpose, technical solution and advantages of the present disclosure to be clearer and understood, the exemplary embodiments of the present disclosure will be further explained in detail below in conjunction with the figures. The examples of these preferred embodiments are illustrated in the drawings. The embodiments of the present disclosure illustrated in the drawings and described according to the drawings are only exemplary, and the present disclosure is not limited to these embodiments.

Here, it needs to be further explained that in order to avoid causing the present disclosure to be vague due to unnecessary details, the structures and/or processes closely related to the solution of the present disclosure are only illustrated in the drawings, while other details which are of less concern about the present disclosure are omitted.

The embodiment provides a liquid crystal display panel as shown in FIG. 4, the liquid crystal display panel 100 includes a thin film transistor array substrate 10 and a color filter substrate 20 disposed opposite to the thin film transistor array substrate 10, a liquid crystal layer 30 is disposed between the thin film transistor array substrate 10 and the color filter substrate 20. The thin film transistor array substrate 10 is provided with a circuit structure for driving display of a pixel structure such as a thin film transistor, a data line, a scan line and a pixel electrode. The color filter substrate 20 includes a black matrix 21 and a color photoresist layer 22 disposed on a base substrate 24, and a protective film layer 23 is further disposed on the color photoresist layer 22. Furthermore, the liquid crystal display panel 100 further includes a bottom polarizer 40 and a top polarizer 50, the bottom polarizer 40 is attached to the thin film transistor array substrate 10, the top polarizer 50 is attached to the color filter substrate 20.

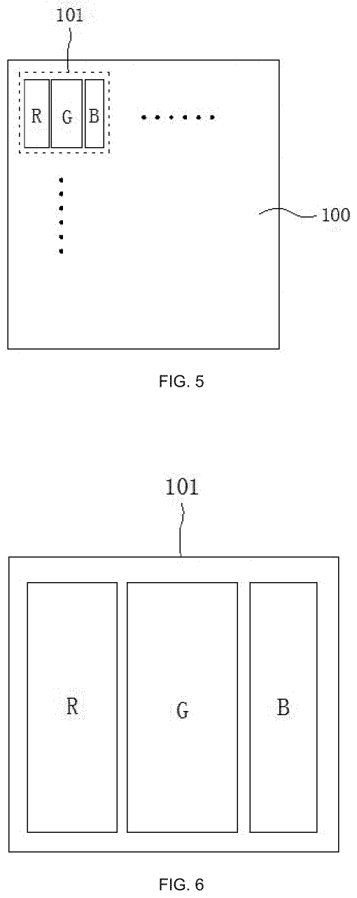

Refer to FIG. 4 and FIG. 5, the liquid crystal display panel 100 includes a plurality of pixel structures 101 arranged in matrix (only one of the pixel structures 101 is shown for example in the drawings). Each of the pixel structures 101 includes a red sub-pixel R, a green sub-pixel G, and a blue subpixel B sequentially arranged, a thin film transistor and a pixel electrode are disposed in the thin film transistor array substrate 10 to correspond to each sub-pixel, and a plurality of photoresists with the corresponding colors are disposed in the color filter substrate 20 to correspond to each color of the sub-pixels. As shown in FIG. 4, a color photoresist layer 22 of the color filter substrate 20 includes a red color photoresist 221, a green color photoresist 222 and a blue color photoresist 223, the red color photoresist 221 is located at the red sub-pixel R, the green color photoresist 222 is located at the green sub-pixel G, and the blue color photoresist 223 is located at the blue sub-pixel B.

Refer to FIG. 4 to FIG. 6, base on the red sub-pixel R in the pixel structure 101 provided by the embodiment, an area Sc of the green sub-pixel G is larger than an area S_{R} of the red sub-pixel R, and an area S_{B} of the blue subpixel B is smaller than the area S_{R} of the red sub-pixel R, that is, S_{B}<S_{R}<S_{G}.

In some embodiments, a ratio of the area S_{G} of the green sub-pixel G to the area S_{R} of the red sub-pixel R may be 1.2˜1.5, that is, S_{G}/S_{R}=1.2˜1.5. A ratio of the area S_{B} of the blue sub-pixel B to the area S_{R} of the red sub-pixel R may be 0.5˜0.8, that is, S_{B}/S_{R}=0.5˜0.8.

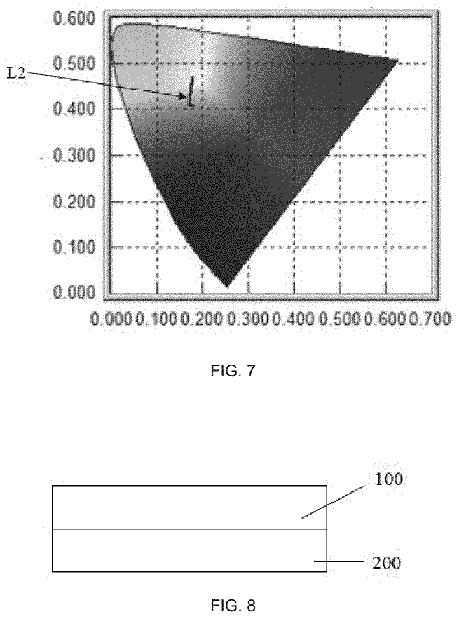

In this embodiment, a ratio of the area S_{R} of the red sub-pixel R to the area S_{G} of the green sub-pixel G to the area S_{B} of the blue sub-pixel B is 1:1.2:0.8. FIG. 7 is chromaticity diagram of a liquid crystal display panel according to this embodiment, the curve L2 is a locus of the variation of the color coordinate of the white point from 0 grayscale to 255 grayscale. Refer to FIG. 7, in the liquid crystal display panel 100 and the pixel structure 101 thereof provided by the above-mentioned embodiment, by increasing the area S_{G} of the green sub-pixel G and decreasing the area S_{B} of the blue sub-pixel B, the green light component (corresponding to the Y component in the color coordinates) is increased and the blue light component is reduced (corresponding to Z component). Therefore, the locus of the color coordinate of the white point of the display panel is modulated, so the problem of the bluish image in low grayscale of the display panel could be solved and the display quality could be increased. In FIG. 7, the color difference parameter=0.063, Compared with the chromaticity diagram of the prior art liquid crystal display panel shown in FIG. 2, the display panel provided in this embodiment can effectively improve the color shift problem.

In addition, in the above-mentioned pixel structure 101 as shown in FIG. 4, when the area S_{G} of the green sub-pixel G is increased, and the area S_{B} of the blue sub-pixel B is decreased, the area of the green color photoresist 222 is correspondingly increased and the blue color photoresist 223 in the color photoresist layer 22 of the liquid crystal display panel 100 is decreased. Since the light transmittance of the green photoresist material is greater than the light transmittance of the blue photoresist material, the pixel structure 101 with the above structure also increases the light transmittance. Therefore, the liquid crystal display panel provided by this embodiment has higher light transmittance than that of the prior art liquid crystal display panel, and improves the utilization rate of the backlight.

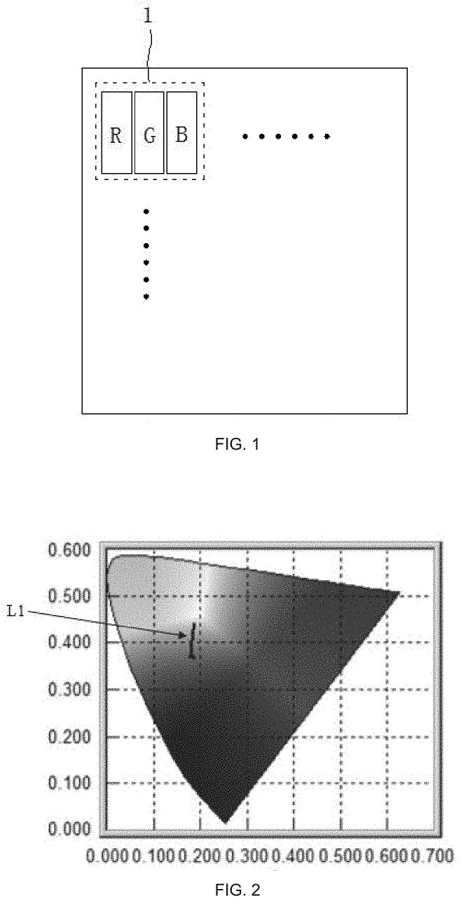

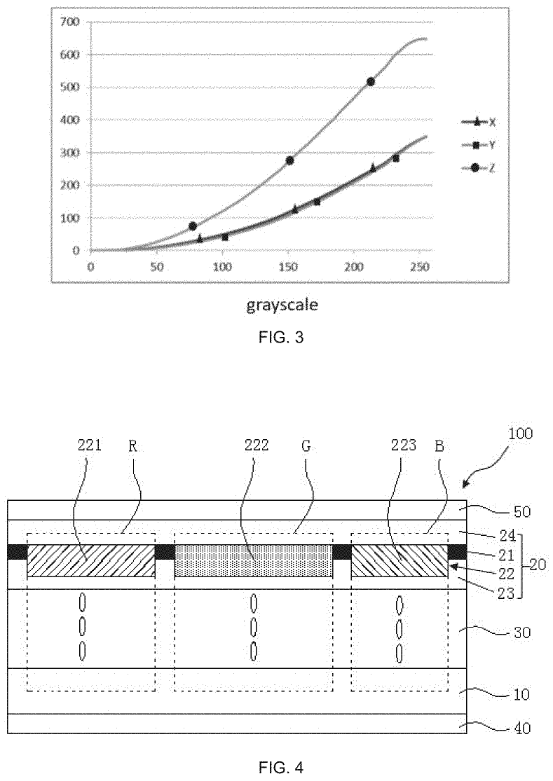

Experimental verification shows that in the liquid crystal display panel shown in FIG. 1, the areas of the red sub-pixel R, the green sub-pixel G and the blue sub-pixel B are equal in size and the overall light transmittance of the liquid crystal display panel is about 11%. In the liquid crystal display panel provided by this embodiment, the total light transmittance of the liquid crystal display panel is about 12.5% after increasing the area S_{G} of the green sub-pixel G and decreasing the area S_{B} of the blue sub-pixel B. Therefore, the light transmittance of the liquid crystal display panel provided by this embodiment is obviously improved.

This embodiment further provides a liquid crystal display device as shown in FIG. 8, the liquid crystal display device includes a liquid crystal display panel 100 and a backlight module 200, the liquid crystal display panel 100 is disposed opposite to the backlight module 200, the backlight module 200 is configured to provide a display light source to the liquid crystal display panel 100, and the liquid crystal display panel 100 is configured to display an image, wherein the liquid crystal display panel 100 is the above-mentioned liquid crystal display panel.

In summary, In the liquid crystal display panel and the pixel structure thereof provided by the embodiment of the disclosure, the locus of the color coordinate of the white point of the display panel is modulated by adjusting the area ratio of each color sub-pixel, so the problem of the bluish image in low grayscale of the display panel could be solved.

It should be explained that the relationship terms, such as first and second, etc., in the present text are only used for distinguishing one entity or operation from another entity or operation without requiring or implying any actual relation or sequence existing between these entities or operations. Moreover, the term “include”, “contain” or any other variant means covering instead of exclusively including, so that the process, method, object or device including a series of factors not only includes those factors but also includes other factors that are not explicitly listed or further include inherent factors for this process, method, object or device. Where no more limitations are provided, the factors defined by the sentence “include one . . . ” do not exclude additional identical factors existing in the process, method, object or device which includes the factors.

The above statements are only the specific embodiments of the disclosure, it should be pointed out that, to those ordinary skilled in the art, several improvements and polish can be made without breaking away from the principle of the disclosure, also those improvements and polish should be considered as the protection scope of the disclosure.

What is claimed is:

1. A pixel structure of a liquid crystal display panel, comprising:
a red sub-pixel, a green sub-pixel, and a blue subpixel sequentially arranged, wherein an area of the green sub-pixel is larger than an area of the red sub-pixel, and an area of the blue subpixel is smaller than the area of the red sub-pixel.

2. The pixel structure of a liquid crystal display panel according to claim 1, wherein a ratio of the area of the green sub-pixel to the area of the red sub-pixel is 1.2˜1.5.

3. The pixel structure of a liquid crystal display panel according to claim 1, wherein a ratio of the area of the blue sub-pixel to the area of the red sub-pixel is 0.5˜0.8.

4. The pixel structure of a liquid crystal display panel according to claim 2, wherein a ratio of the area of the blue sub-pixel to the area of the red sub-pixel is 0.5˜0.8.

5. The pixel structure of a liquid crystal display panel according to claim 4, wherein a ratio of the area of the red sub-pixel to the area of the green sub-pixel to the area of the blue sub-pixel is 1:1.2:0.8.

6. A liquid crystal display panel, comprising a plurality of pixel structures arranged in matrix, each of the pixel structures comprising:
a red sub-pixel, a green sub-pixel, and a blue subpixel sequentially arranged, wherein an area of the green sub-pixel is larger than an area of the red sub-pixel, and an area of the blue subpixel is smaller than the area of the red sub-pixel.

7. The liquid crystal display panel according to claim 6, wherein a ratio of the area of the green sub-pixel to the area of the red sub-pixel is 1.2˜1.5.

8. The liquid crystal display panel according to claim 6, wherein a ratio of the area of the blue sub-pixel to the area of the red sub-pixel is 0.5˜0.8.

9. The liquid crystal display panel according to claim 7, wherein a ratio of the area of the blue sub-pixel to the area of the red sub-pixel is 0.5˜0.8.

10. The liquid crystal display panel according to claim 9, wherein a ratio of the area of the red sub-pixel to the area of the green sub-pixel to the area of the blue sub-pixel is 1:1.2:0.8.

11. The liquid crystal display panel according to claim 6, wherein the liquid crystal display panel comprises a bottom polarizer, a thin film transistor array substrate, a liquid crystal layer, a color filter substrate, and a top polarizer sequentially disposed.

12. A liquid crystal display device, comprising a liquid crystal display panel and a backlight module, the liquid crystal display panel disposed opposite to the backlight module, the backlight module configured to provide a display light source to the liquid crystal display panel and the liquid crystal display panel configured to display an image; the liquid crystal display panel comprising a plurality of pixel structures arranged in matrix, each of the pixel structures comprising:
a red sub-pixel, a green sub-pixel, and a blue subpixel sequentially arranged, wherein an area of the green sub-pixel is larger than an area of the red sub-pixel, and an area of the blue subpixel is smaller than the area of the red sub-pixel.

13. The liquid crystal display device according to claim 12, wherein a ratio of the area of the green sub-pixel to the area of the red sub-pixel is 1.2˜1.5.

14. The liquid crystal display device according to claim 12, wherein a ratio of the area of the blue sub-pixel to the area of the red sub-pixel is 0.5˜0.8.

15. The liquid crystal display device according to claim 13, wherein a ratio of the area of the blue sub-pixel to the area of the red sub-pixel is 0.5˜0.8.

16. The liquid crystal display device according to claim 15, wherein a ratio of the area of the red sub-pixel to the area of the green sub-pixel to the area of the blue sub-pixel is 1:1.2:0.8.

17. The liquid crystal display device according to claim 12, wherein the liquid crystal display panel comprises a bottom polarizer, a thin film transistor array substrate, a liquid crystal layer, a color filter substrate, and a top polarizer sequentially disposed.
